(19) United States
(12) Patent Application Publication
(10) Pub. No.: US 2005/0283555 A1
(43) Pub. Date: Dec. 22, 2005

(54) COMPUTER SYSTEM AND METHOD FOR TRANSMITTING INTERRUPT MESSAGES THROUGH A PARALLEL COMMUNICATION BUS

(75) Inventors: Norman Davies, Barboursville, VA (US); Darrell Hatfield, Faber, VA (US); Frank Kattwinkel, Charlottesville, VA (US); Owen N. Wells, Waynesboro, VA (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/710,141

(22) Filed: Jun. 22, 2004

(51) Int. Cl. G06F 13/36

(52) U.S. Cl. 710/260

(57) ABSTRACT

A computer system and a method for transmitting interrupt messages through a parallel communication bus are provided. The computer system includes a first device operably communicating with a second device via a parallel communication bus. The first device is configured to transmit a first interrupt message through the parallel communication bus to the second device, wherein the first interrupt message has a data portion with a plurality of bits having a first identifier identifying the first device.

### BACKGROUND OF INVENTION

Computer systems have been developed that utilize a Peripheral Component Interconnect (PCI) bus. The PCI bus requires that exactly one PCI host device and one or more non-host PCI devices be operably coupled to the PCI bus. The PCI bus optionally includes a set of interrupt lines that are coupled between the PCI host device and the non-host PCI devices. A non-host PCI device can change a voltage on an interrupt line to interrupt the PCI host device, causing the PCI host device to suspend whatever task it was performing and carry out a higher priority task associated with the interrupt.

The interrupt methods provided by the PCI specification and other similar parallel computer buses like VME have several shortfalls, all of which have a negative impact on the overall speed of the computer system. In particular, whenever one of the interrupt lines is asserted, the interrupted device has to generate one or more bus cycles to determine which interrupting device is asserting the interrupt line, and also to inform the interrupting device that it has received the interrupt signal. As the number of devices coupled to the bus that are capable of generating such an interrupt signal increases, a relatively large amount of processing time is required for the PCI host device to determine which device sent each interrupt signal.

Thus, it is desirable to have a parallel bus system that allows a device receiving an interrupt signal through the bus to relatively quickly determine the identity of the interrupting device.

### SUMMARY OF INVENTION

A computer system in accordance with an exemplary embodiment is provided. The computer system includes a first device operably communicating with a second device via a parallel communication bus. The first device is configured to transmit a first interrupt message through the parallel communication bus to the second device, wherein the first interrupt message has a data portion with a plurality of bits having a first identifier identifying the first device.

A method for transmitting interrupt messages through a parallel communication bus in accordance with another exemplary embodiment is provided. The method includes transmitting a first interrupt message through the parallel communication bus from a first device. The first interrupt message has a data portion with a plurality of bits having a first identifier identifying the first device. Finally, a method includes receiving the first interrupt message at a second device operably coupled to the communication bus. The second device stores the first interrupt message in a first memory location of memory.

An article of manufacture in accordance with another exemplary embodiment is provided. The article of manufacture includes a computer storage medium having a computer program encoded therein for transmitting at least one interrupt message through a parallel communication bus. The computer storage medium includes code for transmitting a first interrupt message through the parallel communication bus from a first device. The first interrupt message has a data portion with a plurality of bits having a first identifier identifying the first device. The computer storage medium further includes code for receiving the first interrupt message at a second device operably coupled to the communication bus. The second device stores the first interrupt message in a first memory location of memory.

Other systems and/or methods according to the embodiments will become or are apparent to one with skill in the art upon review of the following drawings and detailed description. It is intended that all such additional systems and methods be within the scope of the present invention, and be protected by the accompanying claims.

### BRIEF DESCRIPTION OF DRAWINGS

FIG. 1 is a schematic of a computer system in accordance with an exemplary embodiment;

FIG. 2 is a more detailed schematic of a portion of the computer system of FIG. 1;

FIGS. 3 and 4 are flowcharts of a method for transmitting interrupt messages through a parallel communication bus in the computer system of FIG. 1 in accordance with another exemplary embodiment.

### DETAILED DESCRIPTION

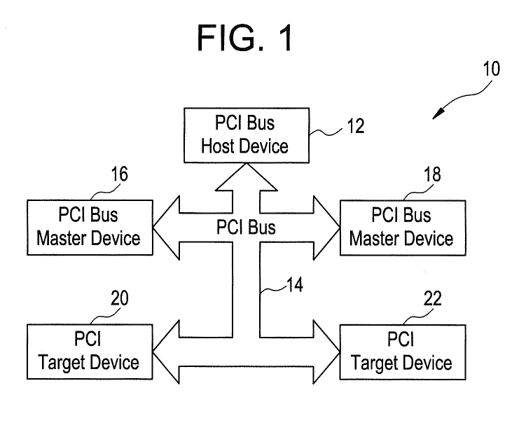

Referring to FIG. 1, a computer system 10 is provided. As shown, the computer system 10 includes a PCI bus host device 12, a PCI bus 14, a PCI bus master device 16, a PCI bus master device 18, a PCI target device 20, and a PCI target device 22. An advantage of the computer system 10 is that the system 10 allows a device coupled to the parallel communication bus to transmit interrupt messages that identify the identity of the sending device. An interrupt signal or interrupt message induces a target device to temporarily suspend the other tasks of the target device, while the target device performs the tasks indicated by the interrupt message.

The PCI host device 12 is provided to perform tasks associated with facilitating communication through the PCI communication bus 14. The PCI host device 12 assigns a unique address range to each of the devices coupled to the PCI communication bus 14. Further, the PCI bus arbiter in the PCI host device 12 authorizes only one device coupled to the bus 14 to initiate a data transfer on the bus 14 at a specific time. In an alternate embodiment, the PCI bus arbiter can reside in a device other than the PCI host device 12.

The PCI bus 14 is provided to facilitate communication between the various devices attached to the bus 14. As shown, the bus 14 is operably coupled to the PCI bus host device 12, the PCI bus master device 16, the PCI bus master device 18, the PCI target device 20, and the PCI target device 22. It should be noted that in an alternate embodiment, the PCI communication bus 14 could be replaced with another type of bus, such as a VME bus for example.

The PCI bus master devices 16, 18 are provided to transmit PCI interrupt messages through the bus 14 to any device operably coupled to the bus 14. The PCI bus master device 16 comprises any device operably coupled to the bus 14 that has the ability to initiate a data transfer on the bus 14. For example, the PCI bus master device can be the PCI bus master device 16, the PCI bus master device 18, and the PCI host device 12. In particular, each of the PCI bus master devices 16 and 18 comprise a computer configured to transmit one or more PCI messages through the bus 14. Further, each of the devices 16 and 18 transmit an interrupt message by performing a bus write cycle through the bus 14 to a particular memory address that is assigned to the target device. Each interrupt message has a data portion with of a plurality of bits that contain information that influences how the receiving device will react to the interrupt message. The information comprises one or more of the following: the identity of the sending device; the priority of the interrupt message; or the reason for the interrupt message. The target device 20 can comprise any of the devices operably coupled to the bus 14. For example, the PCI bus master device 16 can transmit interrupt messages to the PCI bus master device 18, the PCI target device 20, the PCI target device 22, and the PCI host device 12.

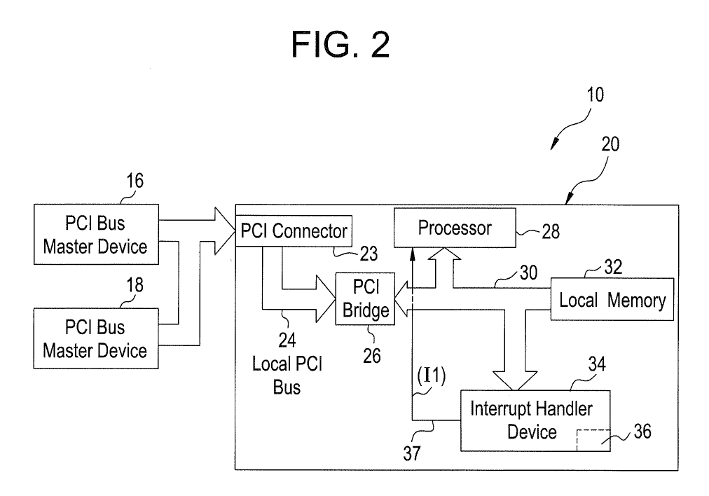

Referring to FIG. 2, a schematic of a portion of the computer system 10 is illustrated including the PCI bus master device 16, the PCI bus master device 18, and the PCI target device 20.

The PCI target device 20 includes a PCI connector 23, a local PCI bus 24, a PCI bridge 26, a processor 28, a local memory bus 30, a memory 32, and an interrupt handler device 34. The PCI connector 23 is provided to operably couple the PCI target device 20 with the PCI communication bus 14. The local PCI bus 24 is operably coupled between the PCI connector 23 and the PCI bridge 26 and routes interrupt messages for the device 20 from the communication bus 14 to the PCI bridge 26. An advantage of the PCI target device 20 is that the target device 20 can queue a plurality of interrupt messages in memory 36 and thereafter execute a plurality of interrupt tasks responsive thereto.

The PCI communication bridge 26 is provided to transmit the received interrupt messages for device 20 through the local memory bus 30 to the interrupt handler device 34. In particular, when the PCI communication bridge 26 receives an interrupt message, the PCI communication bridge 26 performs a bus write cycle to a particular address that is assigned to the interrupt handler device 34. Thereafter, the interrupt handler device 34 writes the interrupt message to a predetermined address in the memory 36. In an alternate embodiment, the interrupt handler device 34 writes the interrupt message to a predetermined address in the memory 32. Further, in another alternate embodiment, the PCI communication bridge 26 can be embedded within the processor 28.

The processor 28 is provided to control communication through the bus 30 and to execute interrupt tasks (e.g., interrupt service request subroutines) in response to interrupt messages. The processor 28 is operably coupled to the bus 30 and is further coupled to the interrupt handler device 34. An interrupt communication line 37 is disposed between the processor 28 and the interrupt handler device 34. When the processor 28 receives an interrupt signal (I1) from the interrupt handler device 34, the processor 28 retrieved an interrupt message stored in memory 36 by the interrupt handler device 34. Thereafter, the processor 28 either: (i) executes a task associated with the interrupt message, or (ii) modifies process state variables such that the processor 28 will execute a task associated with the interrupt message at a future time. Thereafter, if there are more interrupt messages in the queue that have not been retrieved by the processor 28, the processor 28 continues to receive an interrupt signal from the interrupt handler device 34. In response to receiving the interrupt signal, processor 28 continues to retrieve interrupt messages from the queue and execute tasks associated with those interrupt messages until the queue becomes empty.

In an alternate embodiment, the interrupt handler device 34 sends another distinct interrupt signal to the processor 28 to indicate that an interrupt message is still pending. In yet another alternate embodiment, a protocol between processor 28 and the interrupt handler device 34 is defined such that the processor 28 determines if the interrupt queue is empty.

In still another alternate embodiment of the target device 20, a plurality of additional interrupt communication lines are disposed between the processor 28 and the interrupt handler device 34. Each interrupt communication line is configured to transmit a signal indicative of a distinct interrupt message. When the processor 28 receives a signal from the interrupt handler device 34 via an interrupt communication line, the processor 28 executes a task associated with that interrupt communication line. Thus, in this alternate embodiment, the processor 28 does not need to read the interrupt message from any device to determine which interrupt task to execute. Instead, the interrupt handler device 34 indicates the type of interrupt by transmitting a signal over a predetermined interrupt communication line of the plurality of interrupt communication lines to the processor 28.

The interrupt handler device 34 is operably coupled to the bus 30 and is configured to receive and store interrupt messages received from any PCI bus master device couple to the bus 14. As shown, the interrupt handler device 34 contains the internal memory device 36. In particular, the interrupt handler device 34 is configured to determine a memory address within the memory 36 for storing each interrupt message. Further, the device 34 is configured to transmit a signal (I1) to the processor 28 through the interrupt communication line 37 indicating that an interrupt message was received and stored within the memory 36. The interrupt handler device 34 comprises an application-specific integrated circuit (ASIC). In alternate embodiments, the interrupt handler device 34 can comprise a configurable programmable logic device (CPLD), a field programmable gate array (FPGA), a custom masked logic device, or other logical devices.

In an alternate embodiment, the interrupt handler device 34 does not have internal memory 36, but instead writes to a local memory 32 to store interrupt messages. Thus, the interrupt handler device 34 writes to the local memory 32 to store the messages, and the processor 28 reads from the local memory 32 to retrieve interrupt messages.

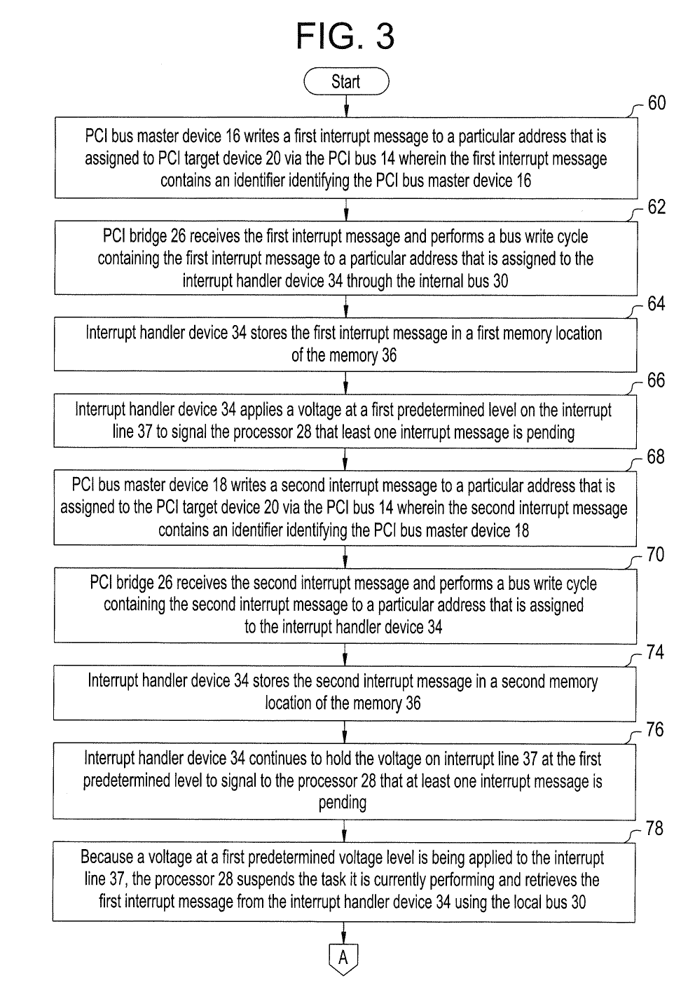

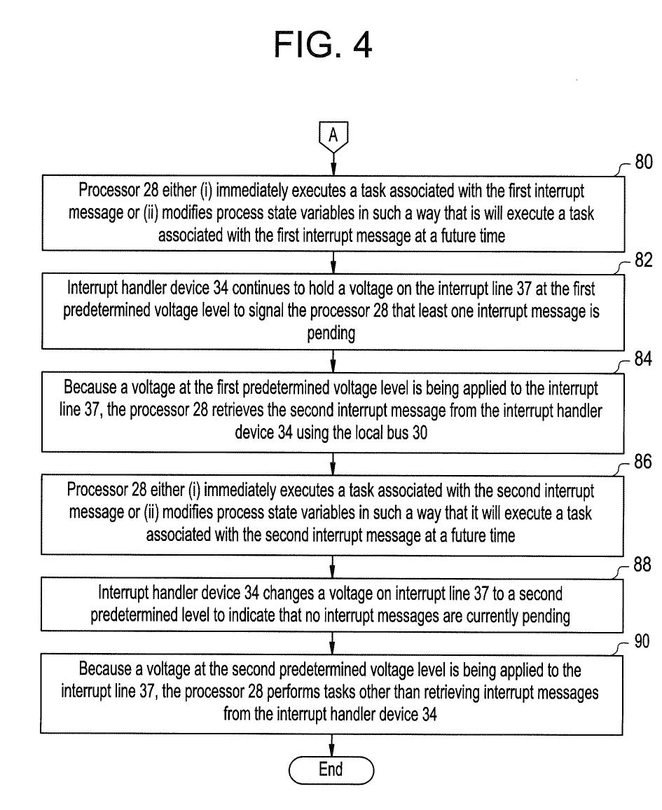

Referring now to FIGS. 3 and 4, a method for transmitting interrupt messages through a parallel communication bus will be explained.

At step 60, the PCI bus master device 16 writes a first interrupt message to a particular address that is assigned to PCI target device 20 via the PCI bus 14 wherein the first interrupt message contains an identifier identifying the PCI bus master device 16.

At step 62, the PCI bridge 26 receives the first interrupt message and performs a bus write cycle containing the first interrupt message to a particular address that is assigned to the interrupt handler device 34 through the internal bus 30.

At step 64, the interrupt handler device 34 stores the first interrupt message in a first memory location of the memory 36.

At step 66, the interrupt handler device 34 applies a voltage at a first predetermined level on the interrupt line 37 to signal the processor 28 that least one interrupt message is pending.

At step 68, the PCI bus master device 18 writes a second interrupt message to a particular address that is assigned to the PCI target device 20 via the PCI bus 14 wherein the second interrupt message contains an identifier identifying the PCI bus master device 18.

At step 70, the PCI bridge 26 receives the second interrupt message and performs a bus write cycle containing the second interrupt message to a particular address that is assigned to the interrupt handler device 34 through the internal bus 30.

At step 74, the interrupt handler device 34 stores the second interrupt message in a second memory location of the memory 36.

At step 76, the interrupt handler device 34 continues to hold the voltage on interrupt line 37 at the first predetermined level to signal to the processor 28 that at least one interrupt message is pending.

At step 78, because a voltage at a first predetermined voltage level is being applied to the interrupt line 37, the processor 28 suspends the task it is currently performing and retrieves the first interrupt message from the interrupt handler device 34 using the local bus 30.

At step 80, the processor 28 either (i) immediately executes a task associated with the first interrupt message or (ii) modifies process state variables in such a way that it will execute a task associated with the first interrupt message at a future time.

At step 82, the interrupt handler device 34 continues to hold a voltage on the interrupt line 37 at the first predetermined voltage level to signal the processor 28 that at least one interrupt message is pending.

At step 84, because a voltage at the first predetermined voltage level is being applied to the interrupt line 37, the processor 28 retrieves the second interrupt message from the interrupt handler device 34 using the local bus 30.

At step 86, the processor 28 either (i) immediately executes a task associated with the second interrupt message or (ii) modifies process state variables in such a way that it will execute a task associated with the second interrupt message at a future time.

At step 88, the interrupt handler device 34 changes a voltage on interrupt line 37 to a second predetermined level to indicate that no interrupt messages are currently pending.

Finally, at step 90, because a voltage at the second predetermined voltage level is being applied to the interrupt line 37, the processor 28 performs tasks other than retrieving interrupt messages from the interrupt handler device 34.

The computer system and the method for transmitting interrupt messages provide a substantial advantage over other systems and methods. In particular, the system and method provide a technical effect of allowing a sending device coupled to parallel communication bus to transmit interrupt messages containing an identifier which identifies the sending device to a receiving device.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and/or executed by a computer, the computer becomes an apparatus for practicing the invention. When implemented on a general-purpose microprocessor, the computer program code segments configure the microprocessor to create specific logic circuits.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

1. A computer system, comprising:
a first device operably communicating with a second device via a parallel communication bus, the first device configured to transmit a first interrupt message through the parallel communication bus to the second device, wherein the first interrupt message has a data portion with a plurality of bits having a first identifier identifying the first device.

2. The computer system of claim 1, wherein the parallel communication bus comprises one of a PCI communication bus, a PCI-X communication bus, a CompactPCI communication bus, a VME communication bus, a VME64 communication bus, and a VME64× communication bus.

3. The computer system of claim 1, further comprising a third device operably coupled to the parallel communication bus, the third device configured to transmit a second interrupt message through the parallel communication bus to the second device, wherein the second interrupt message has a data portion with a plurality of bits having a second identifier identifying the third device.

4. The computer system of claim 1, further comprising a third device operably coupled to the parallel communication bus, the first device configured to transmit a second interrupt message through the parallel communication bus to the third device, wherein the second interrupt message has a data portion with a plurality of bits having a second identifier identifying the first device.

5. The computer system of claim 1, wherein the data portion of the first interrupt message further comprises an interrupt command identifying a task for the second device to perform.

6. The computer system of claim 1, wherein the second device is configured to receive the first interrupt message and to perform at least one task associated with the first identifier.

7. The computer system of claim 1, wherein the first device writes the first interrupt message through the parallel communication bus to the second device.

8. The computer system of claim 1, wherein the first interrupt message induces the second device to stop performing other tasks not associated with the first interrupt message.

9. The computer system of claim 1, wherein the second device comprises a bridge communication device, a processor, an interrupt handler device, and an internal bus operably coupled to the bridge communication device, the processor, and the interrupt handler device, the bridge communication device receiving the first interrupt message and transmitting the first interrupt message to the interrupt handler device.

10. The computer system of claim 9, wherein the interrupt handler device receives the first interrupt message and stores the first interrupt message in a first memory location of a memory, the interrupt handler device transmitting a first signal to the processor indicating that the first interrupt message has been stored in the memory, the processor retrieving the first interrupt message from the first memory location in response to the first signal.

11. The computer system of claim 10, wherein the processor performs at least one task associated with the first interrupt message after reading the first interrupt message.

12. The computer system of claim 9, wherein the interrupt handler device receives the first interrupt message and stores the first interrupt message in a first memory location of a memory, the interrupt handler device transmitting one of a plurality signals to the processor indicating the type of interrupt received, the processor retrieving the first interrupt message from the first memory location in response to the one of the plurality of signals.

13. The computer system of claim 12, wherein the processor performs at least one task associated with the first interrupt message after retrieving the first interrupt message.

14. A method for transmitting interrupt messages through a parallel communication bus, the method comprising:
transmitting a first interrupt message through the parallel communication bus from a first device, the first interrupt message having a data portion with a plurality of bits having a first identifier identifying the first device; and
receiving the first interrupt message at a second device operably coupled to the communication bus, the second device storing the first interrupt message in a first memory location of a memory.

15. The method of claim 14, further comprising retrieving the first interrupt message from the memory and performing at least one task associated with the first interrupt message based on the first identifier.

16. The method of claim 14, wherein the data portion of the first interrupt message further comprises an interrupt command identifying a task for the second device to perform.

17. The method of claim 14, wherein the parallel communication bus comprises one of a PCI communication bus, a PCI-X communication bus, a CompactPCI communication bus, a VME communication bus, a VME64 communication bus, and a VME64× communication bus.

18. The method of claim 14, further comprising:
transmitting a second interrupt message through the parallel communication bus from a third device, the second interrupt message having a data portion with a plurality of bits having a second identifier identifying the third device; and
receiving the second interrupt message at the second device operably coupled to the communication bus, the second device storing the second interrupt message in a second memory location of the memory.

19. An article of manufacture, comprising:
a computer storage medium having a computer program encoded therein for transmitting at least one interrupt message through a parallel communication bus, the computer storage medium comprising:
code for transmitting a first interrupt message through the parallel communication bus from a first device, the first interrupt message having a data portion with a plurality of bits having a first identifier identifying the first device;
code for receiving the first interrupt message at a second device operably coupled to the communication bus, the second device storing the first interrupt message in a first memory location of a memory.

20. The article of manufacture of claim 19, wherein the parallel communication bus comprises one of a PCI communication bus, a PCI-X communication bus, a CompactPCI communication bus, a VME communication bus, a VME64 communication bus, and a VME64× communication bus.

21. The article of manufacture of claim 19, wherein the computer storage medium, further comprises:
code for transmitting a second interrupt message through the parallel communication bus from a third device, the second interrupt message having a data portion with a plurality of bits having a second identifier identifying the third device; and
code for receiving the second interrupt message at the second device operably coupled to the communication bus, the second device storing the second interrupt message in a second memory location of the memory.
